(19) United States
(12) Patent Application Publication
(10) Pub. No.: US 2026/0298005 A1
(43) Pub. Date: Oct. 1, 2026

(54) DUAL ACTION POWER GATE

(71) Applicant: STRATTEC POWER ACCESS LLC, Auburn Hills, MI (US)

(72) Inventors: Gregory V. Sproule, Linden, MI (US); Daniel A. Ney, Lake Orion, MI (US); Curtis A. Braun, Lake Orion, MI (US); Jacob D. Fritschle, Rochester Hills, MI (US)

(21) Appl. No.: 19/554,853

(22) Filed: Mar. 3, 2026

Related U.S. Application Data
(60) Provisional application No. 63/781,775, filed on Apr. 1, 2025.

(51) Int. Cl. E05F 15/614

(52) U.S. Cl. CPC E05F 15/614; E05Y 2900/50

(57) ABSTRACT

A dual action power gate includes a gate for a vehicle that is configured to rotate about a first axis and a second axis different than the first axis. The dual action power gate further includes a power actuator system coupled to the gate and configured to rotate the gate about each of the first axis and the second axis.

### CROSS-REFERENCE TO RELATED APPLICATIONS

This application claims priority to U.S. Provisional Application No. 63/781,775, filed Apr. 1, 2025, the entire contents of which are incorporated herein by reference.

### FIELD

This disclosure relates generally to gates on vehicles, including tailgates on motor vehicles that are rotatable about two separate axes.

### SUMMARY

In one aspect, the disclosure provides a dual action power gate having a gate configured to rotate about a first axis and a second axis different than the first axis. The dual action power gate further includes a power actuator system coupled to the gate and configured to rotate the gate about each of the first axis and the second axis.

Other aspects of the disclosure will become apparent by consideration of the detailed description and accompanying drawings.

### BRIEF DESCRIPTION OF THE DRAWINGS

FIG. 1 is a schematic illustration of a dual action power gate according to one example.

FIGS. 2 and 3 are schematic illustrations of the dual action power gate of FIG. 1, illustrating a swing event about a first rotational axis.

FIGS. 4 and 5 are schematic illustrations of the dual action power gate of FIG. 1, illustrating a lift event about a second rotational axis.

FIG. 6 is a schematic illustration of a power actuator system of the dual action power gate of FIG. 1.

FIG. 7 is a schematic illustration of a gearbox of the power actuator system, illustrating movement about both the first rotational axis and the second rotational axis.

FIG. 8 is a schematic illustration of a control process for both the swing event and the lift event for the dual action power gate of FIG. 1.

FIG. 9 is a schematic illustration of a dual action power gate according to another example.

FIGS. 10 and 11 are schematic illustrations of the dual action power gate of FIG. 9, illustrating a swing event about a first rotational axis.

FIGS. 12 and 13 are schematic illustrations of the dual action power gate of FIG. 9, illustrating a lift event about a second rotational axis.

FIG. 14 is a schematic illustration of a power actuator system of the dual action power gate of FIG. 9.

FIG. 15 is a schematic illustration of a control process for both the swing event and the lift event for the dual action power gate of FIG. 9.

FIG. 16 is a schematic illustration of a dual action power gate according to another example.

FIG. 17 is a side view of a portion of a dual action power gate according to another example.

FIG. 18 is a perspective, partial cross-sectional view of the portion of the dual action power gate of FIG. 17.

### DETAILED DESCRIPTION

Before any examples of the present disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways.

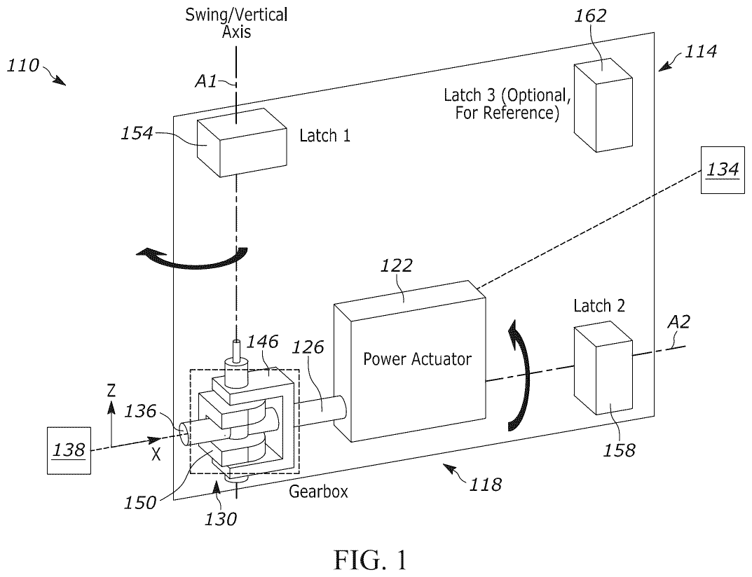

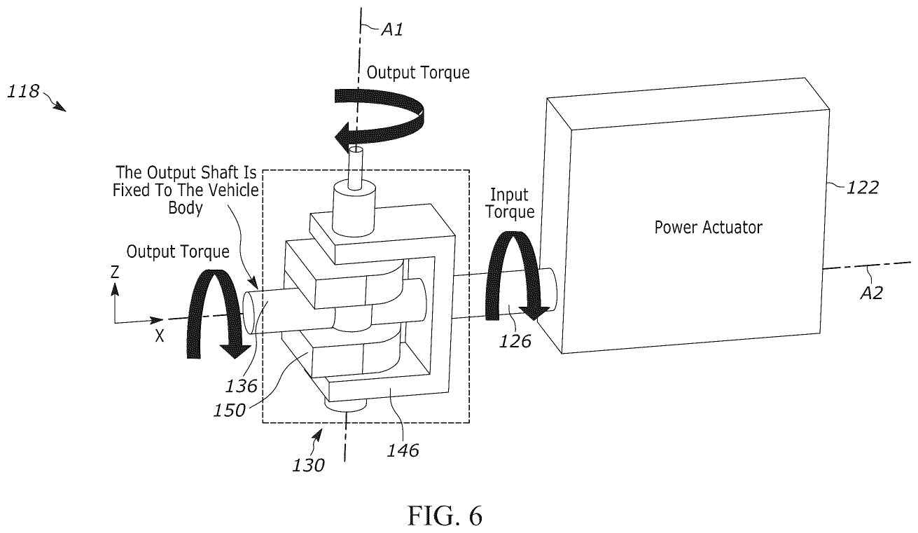

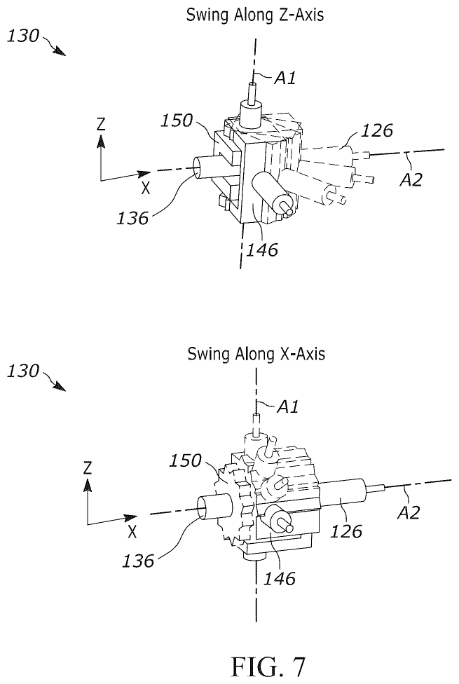

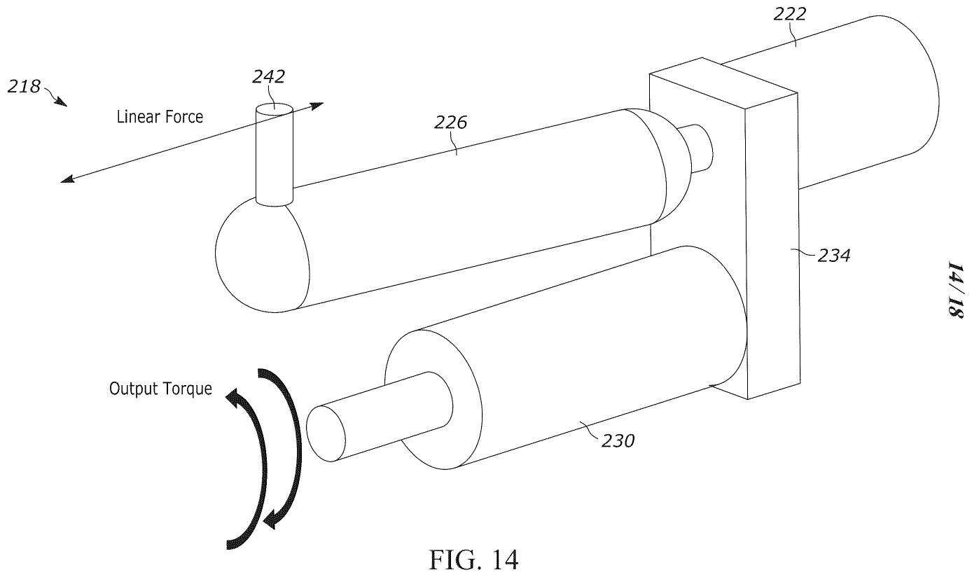

FIGS. 1-18 illustrate various dual action power gates. The dual action power gates may be used on a motor vehicle, or on any other component other than a motor vehicle. As described in detail below, the dual action power gates may be powered to rotate a gate about at least two different axes (e.g., a vertical axis and a horizontal axis).

With reference to FIGS. 1-8, one example of a dual action power gate 110 includes a gate 114 that rotates both about each of a first axis A1 (e.g., a vertical axis) and a second axis A2 (e.g., a horizontal axis) different than the first axis A1. The gate 114 may be any type of gate, including for example a lift gate on a vehicle, a tail gate on a vehicle, a hood on a vehicle, a frunk on a vehicle, a side door on a vehicle, or any other type of door or closure. In the illustrated example, the first axis A1 is perpendicular to the second axis A2, although in other examples the first axis A1 extends at a different angle relative to the second axis A2.

The dual action power gate 110 further includes a power actuator system 118 coupled to the gate 114 to rotate the gate 114 about each of the first axis A1 and the second axis A2. The power actuator system 118 includes a power actuator 122, a power actuator output member 126 (e.g., an output shaft) coupled to and extending from the power actuator 122, and/or a gearbox 130 coupled to the power actuator output member 126.

The power actuator 122 may be any type of power actuator, including for example an electric motor or other type of motor or actuator. In the illustrated example, the power actuator 122 is an electric motor coupled (e.g., at least partially fixed) to the gate 114, such that the power actuator 122 moves with the gate 114 when the gate rotates about the first axis A1 and also when the gate 114 rotates about the second axis A2.

The power actuator output member 126 may be any type of power actuator output member, including for example an elongate shaft (e.g., torsion shaft). In the illustrated example, the power actuator output member 126 is an elongate torsion shaft extending along the second axis A2, and into the gearbox 130. Other examples include other shapes, sizes, and/or types of power output members than that illustrated, and also different manners of connection of the power actuator output member 126 (or other component of the power actuator system 118) to a vehicle body.

With continued reference to FIG. 1, in the illustrated example the power actuator 122 is coupled (e.g., wirelessly) to a controller 134 that is located for example within the motor vehicle. When activated (e.g., via the controller 134), the power actuator 122 generates a torque and/or a rotation of the power actuator output member 126 about the second axis A2. In other examples, the power actuator 122 may generate other types of forces (e.g., a torque, linear translating force, and/or other force), to the power actuator output member 126 or other member of the power actuator system 118. Other examples may not include the controller 134, and/or may include other control mechanisms for controlling the power actuator 122.

With continued reference to FIG. 1, the gearbox 130 (illustrated schematically) may be any type of gearbox that generates motion about one or more axes (such as the first axis A1 and/or the second axis A2), based on input from at least one power actuator (e.g., the power actuator 122). The gearbox 130 may function as, and/or include, and/or be part of, a dual hinge structure. In the illustrated example, the gearbox 130 is coupled (e.g., at least partially fixed) to the gate 114, such that at least a first portion 146 of the gearbox 130 (e.g., serving as part of a dual hinge) moves with the gate 114 when the gate 114 rotates about the first axis A1 and such that at least a second portion 150 of the gearbox 130 (e.g., serving as another part of a dual hinge) moves with the gate 114 when the gate 114 rotates about the second axis A2. In other examples, the gearbox 130 may only include a first portion that moves with the gate 114 when the gate rotates about the first axis A1.

As illustrated in FIG. 1, the gearbox 130 may additionally include, or be coupled to, an anchoring member 136. In the illustrated example, the anchoring member 136 is coupled to a vehicle body 138. The anchoring member 136 is coupled to the second portion 150 of the gearbox 130, and the power actuator output member 126 is coupled to the first portion 146 of the gearbox 130. Other examples include various other arrangements of anchoring members, power actuator output members, and/or gearboxes than that illustrated.

In some examples, the gearbox 130 functions similar to a differential gearbox for a motor vehicle, and includes various gears (e.g., toothed gears), linkages, and/or other members that each rotate or otherwise move relative to the first axis A1 and/or the second axis A2, to generate different relative motions of the gate 114 about the first axis A1 and the second axis A2. For example, the gearbox 130 may be arranged such that when the gate 114 is prevented from rotating about the first axis A1, the power transmitted to the gearbox 130 (e.g., through the power actuator output member 126) is directed (e.g., entirely) to rotating the gate 114 about the second axis A2. Similarly, when the gate 114 is prevented from rotating about the second axis A2, the power transmitted to the gearbox 130 (e.g., through the power actuator output member 126) is directed (e.g., entirely) to rotating the gate 114 about the first axis A1.

With continued reference to FIG. 1, the dual action power gate 110 further includes at least one latch that may be locked and unlocked relative to the vehicle body 138 (e.g., manually and/or via electronic control, such as through the use of the controller 134). The latch or latches are used, for example, to control (e.g., inhibit or permit) movement of the gate 114 about the first axis A1 and/or the second axis A2.

In the illustrated example, the dual action power gate 110 includes a first latch 154, a second latch 158, and a third latch 162. Other examples include other numbers and arrangements of latches. For example, the dual action power gate 110 may only include the first latch 154 and the second latch 158, or may include more than three latches.

As seen in FIG. 1, the first latch 154 is positioned along the first axis A1 (e.g., at a first upper corner of the gate 114), the second latch 158 is positioned along the second axis A2 (e.g., at a lower corner of the gate 114), and the third (e.g., optional) latch 162 is positioned at a distance from both the first axis A1 and the second axis A2 (e.g., at a second upper corner of the gate 114). Other examples include different locations for the latches than that shown. In some examples, at least a portion of at least one of the first latch 154, the second latch 158, and/or the third latch 162 is coupled (e.g., at least partially fixed) to the gate 114, and thus moves with the gate 114 when the gate rotates about both the first axis A1 and the second axis A2. In some examples, at least a portion of at least one of the first latch 154, the second latch 158, and/or the third latch 162 is coupled (e.g., at least partially fixed) to the vehicle body 138.

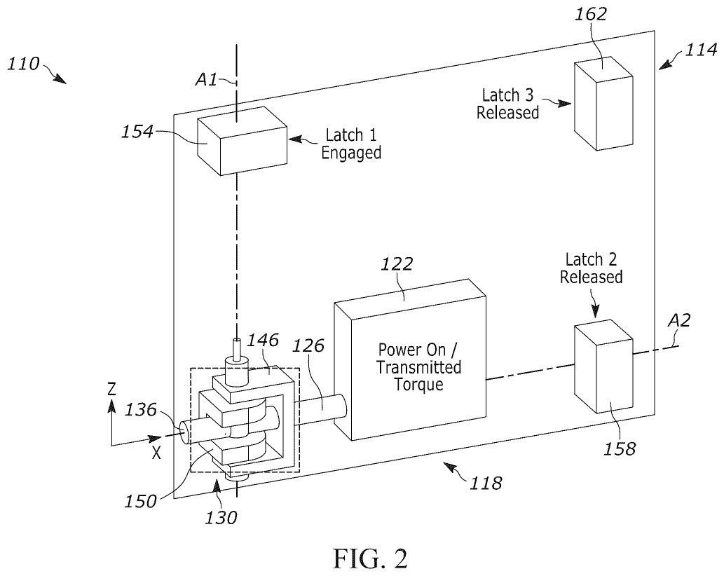

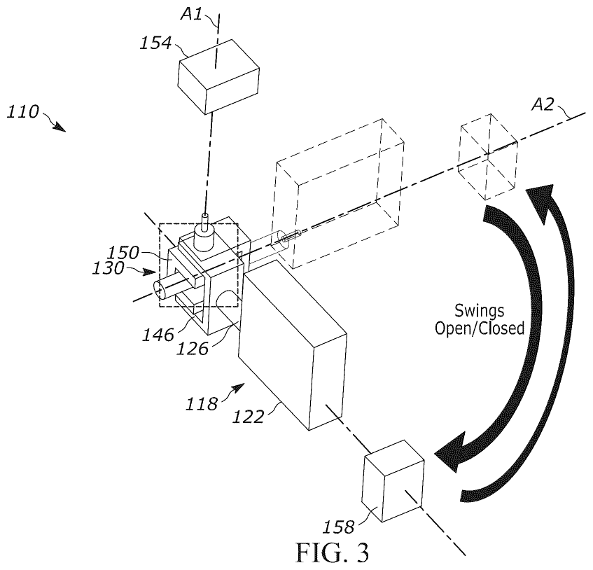

With reference to FIGS. 2 and 3, the power actuator system 118 may be free to rotate the gate 114 about the first axis A1 (in what may be considered a “swing” event) when the first latch 154 is locked (e.g., engaged with the vehicle body 138) and the second latch is unlocked (e.g., released from the vehicle body 138). As described above, the dual action power gate 110 may additionally include the third latch 162. Accordingly, in the illustrated example the power actuator system 118 is free to rotate the gate 114 about the first axis A1 when the first latch 154 is locked, and when both the second latch 158 and the third latch 162 are unlocked.

To rotate the gate 114 about the first axis A1, the power actuator 122 may be activated (e.g., via the controller 134), thereby generating torque through the power actuator output member 126 and into the gearbox 130. Because the second latch 158 is locked, the gate 114 is unable to rotate about the second axis A2. Accordingly, the power transmitted through the power actuator output member 126 is directed (e.g., entirely) to rotating the gate 114 instead about the first axis A1.

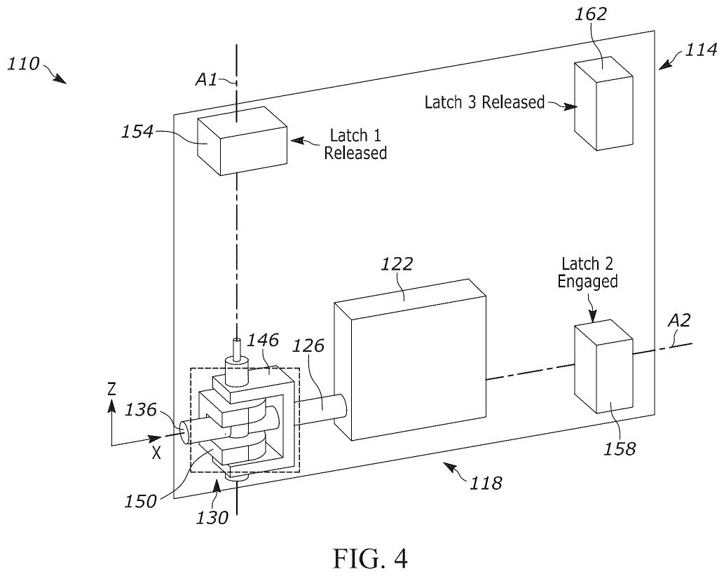

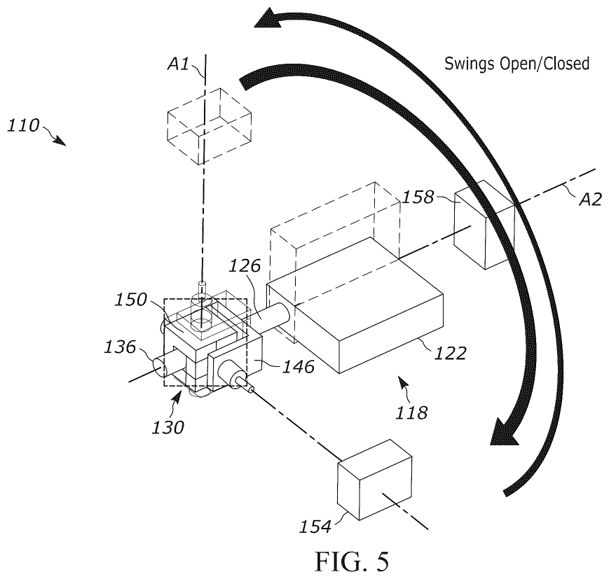

With reference to FIGS. 4 and 5, in some examples the power actuator system 118 may be free to rotate the gate 114 about the second axis A2 (in what may be considered a “lift” event) when the first latch 154 is unlocked (e.g., released from the vehicle body 138) and the second latch 158 is locked (e.g., engaged with the vehicle body 138). In the illustrated example, and as described above, the dual action power gate 110 may additionally include the third latch 162. Accordingly, in the illustrated example the power actuator system 118 is free to rotate the gate 114 about the second axis A2 when the first latch 154 and the third latch 162 are unlocked, and when the second latch 158 is locked.

To rotate the gate 114 about the second axis A2, the power actuator 122 may be activated (e.g., via the controller 134), thereby generating torque through the power actuator output member 126 and into the gearbox 130. Because the first latch 154 is locked, the gate 114 is unable to rotate about the first axis A1. Accordingly, the power transmitted through the power actuator output member 126 is directed (e.g., entirely) to rotating the gate 114 instead about the second axis A2.

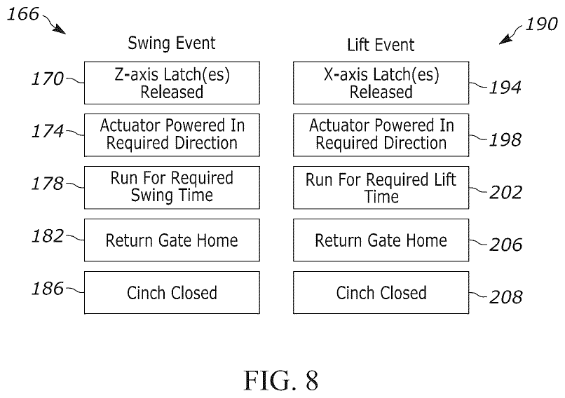

FIG. 8 illustrates an example of a control process 166 for a swing event of the dual action power gate 110. The control process 166 may be implemented, for example partially or entirely by the controller 134. As illustrated in FIG. 8, the control process 166 includes a step 170 of releasing at least one latch along the second axis A2 (e.g., the second latch 158). The control process 166 further includes a step 174 of powering the power actuator 122 in a required direction (e.g., to cause a rotation of the power actuator output member 126 in a required direction). The control process 166 further includes a step 178 of allowing the power actuator 122 to run for a specified period of time (i.e., a “swing” time). The control process 166 further includes a step 182 of returning the gate 114 back to a home position (e.g., by reversing the required direction). The control process 166 further includes a step 186 of cinching the gate 114 closed (e.g., with a cinching mechanism or mechanisms). Other examples of the control process 166 may include more, or fewer, steps than that illustrated.

FIG. 8 additionally illustrates an example of a control process 190 for a lift event of the dual action power gate 110. The control process 190 may be implemented, for example partially or entirely by the controller 134. As illustrated in FIG. 8, the control process 190 includes a step 194 of releasing at least one latch along the first axis A1 (e.g., the first latch 154). The control process 190 further includes a step 198 of powering the power actuator 122 in a required direction (e.g., to cause a rotation of the power actuator output member 126 in a required direction). The control process 190 further includes a step 202 of allowing the power actuator 122 to run for a specified period of time (i.e., a “lift” or “drop” time). The control process 190 further includes a step 206 of returning the gate 114 back to a home position (e.g., by reversing the required direction). The control process 190 further includes a step 208 of cinching the gate 114 closed (e.g., with a cinching mechanism or mechanisms). Other examples of the control process 190 may include more, or fewer, steps than that illustrated.

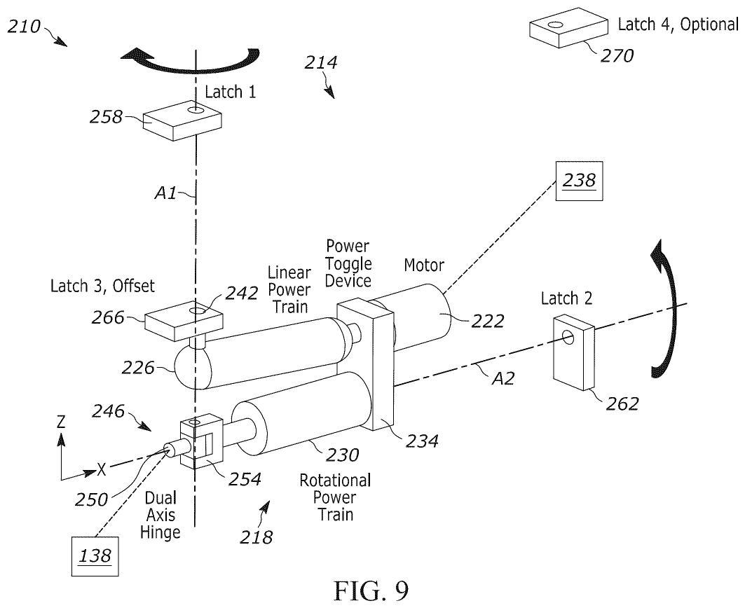

With reference to FIGS. 9-15, another example of a dual action power gate 210 includes a gate 214 that rotates both about each of the first axis A1 and the second axis A2. The gate 214 may be any type of gate, including for example a lift gate on a vehicle, a tail gate on a vehicle, a hood on a vehicle, a frunk on a vehicle, or a side door on a vehicle.

The dual action power gate 110 further includes a power actuator system 218 coupled to the gate 214 to rotate the gate 214 about each of the first axis A1 and the second axis A2. The power actuator system 218 includes a power actuator 222, a first (e.g., linear) power train 226 coupled to the power actuator 222, and a second (e.g., rotational) power train 230 coupled to the power actuator 222. The first power train 226 is separate from the second power train 230.

The power actuator 222 may be any type of power actuator, including for example an electric motor or other type of motor or actuator. In the illustrated example, the power actuator 222 is an electric motor coupled (e.g., at least partially fixed) to the gate 214, such that the power actuator 222 moves with the gate 214 when the gate rotates about the first axis A1 and also when the gate 214 rotates about the second axis A2.

In the illustrated example, the first power train 226 is coupled to the power actuator 222 via a transmission 234 (e.g., having one or more gears and/or clutches). Similarly, the second power train 230 is coupled to the power actuator 222 via the transmission 234.

With continued reference to FIG. 9, the power actuator 222 is coupled (e.g., wirelessly) to a controller 238 that is located for example within the motor vehicle. The controller 238 may be programmed to control whether power is directed from the power actuator 222 to the first power train 226 or to the second power train 230. For example, the transmission 234 and/or each of the first power train 226 and the second power train 230 may include one or more clutches or other structures that are selectively engaged or disengaged to control power transmission from the power actuator 222 to either the first power train 226 or the second power train 230.

When activated (e.g., via the controller 238), the power actuator 222 thus generates a force (e.g., torque, linear translating force, and/or other force) that is transmitted through the transmission 234 and to one of the first power train 226 or the second power train 230. Other examples may not include the controller 238, and/or may include other control mechanisms for controlling the power actuator 222.

With continued reference to FIG. 9, in the illustrated example the first power train 226 includes a distal shaft 242 (e.g., pivot shaft) that is aligned along the first axis A1. The second power train 230 is coupled to a dual axis hinge 246, aligned along both the first axis A1 and the second axis A2. The dual axis hinge 246 includes a first, anchoring member 250 coupled to the vehicle body 138, and a second member 254 pivotally coupled to the first, anchoring member 250. Other examples include various other arrangements of shafts, dual axis hinges, and/or anchoring members than that illustrated.

With continued reference to FIG. 9, the dual action power gate 210 further includes at least one latch that may be locked and unlocked relative to the vehicle body 138 (e.g., manually and/or via electronic control, such as through the use of the controller 238). The latch or latches are used, for example, to control (e.g., inhibit or permit) movement of the gate 214 about the first axis A1 and/or the second axis A2.

In the illustrated example, the dual action power gate 210 includes a first latch 258, a second latch 262, a third latch 266, and a fourth latch 270. Other examples include other numbers and arrangements of latches. For example, the dual action power gate 210 may only include the first latch 258, the second latch 262, and the third latch 266, or may include more than four latches.

As seen in FIG. 9, the first latch 258 is positioned along the first axis A1 (e.g., at a first upper corner of the gate 214), the second latch 262 is positioned along the second axis A2 (e.g., at a lower corner of the gate 214), the third (e.g., offset) latch 266 is positioned along the first axis A1 and is releasably coupled to the distal shaft 242, and the fourth latch 270 is positioned at a distance from both the first axis A1 and the second axis A2 (e.g., at a second upper corner of the gate 214). Other examples include different locations for the latches than that shown. In some examples, at least a portion of at least one of the first latch 258, the second latch 262, the third latch 266, and/or the fourth latch 270 is coupled (e.g., at least partially fixed) to the gate 214, and thus moves with the gate 214 when the gate rotates about both the first axis A1 and the second axis A2. In some examples, at least a portion of at least one of the first latch 258, the second latch 262, the third latch 266, and/or the fourth latch 270 is coupled (e.g., at least partially fixed) to the vehicle body 138.

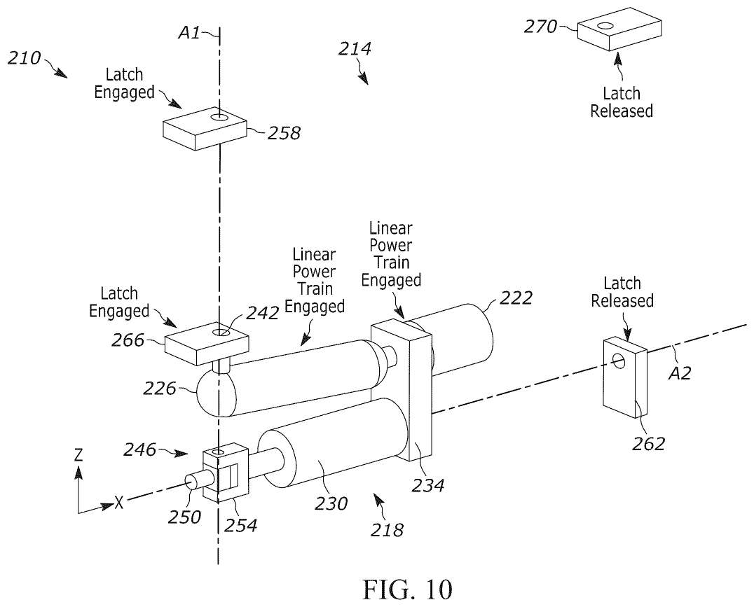

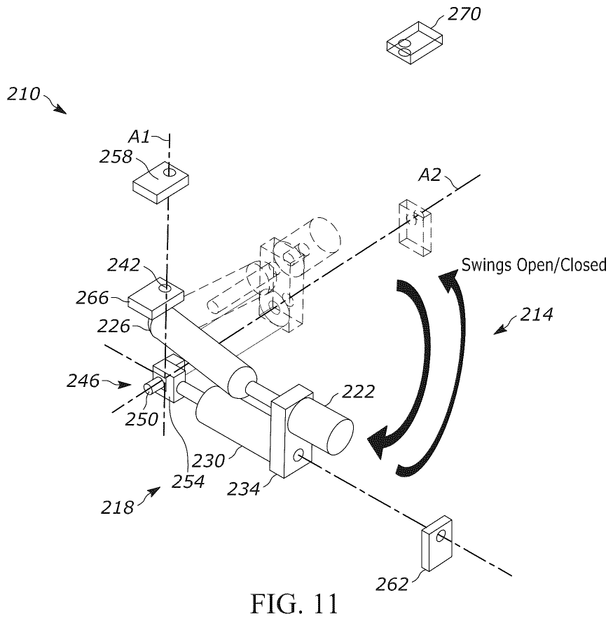

With reference to FIGS. 10 and 11, the power actuator system 218 may be free to rotate the gate 214 about the first axis A1 (in what may be considered a “swing” event) when both the first latch 258 and the third latch 266 are locked (e.g., engaged with the vehicle body 138 and/or the distal shaft 242) and the second latch 262 is unlocked (e.g., released from the vehicle body 138). As described above, the dual action power gate 210 may additionally include the fourth latch 270. Accordingly, in the illustrated example the power actuator system 218 is free to rotate the gate 214 about the first axis A1 when both the first latch 258 and the third latch 266 are locked, and when both the second latch 262 and the fourth latch 270 are unlocked.

To rotate the gate 214 about the first axis A1, the power actuator 222 may be activated (e.g., via the controller 238), thereby generating a force that is transmitted through the transmission 234 to the first power train 226. As described above, the transmission 234 may include a clutch or clutches or other structures that may be moved (e.g., via control from the controller 238) to shift the power output to the first power train 226 (as opposed to the second power train 230).

Because the second latch 262 is locked, the gate 214 is unable to rotate about the second axis A2. Accordingly, the power transmitted through the first power train 226 is directed (e.g., entirely) to rotating the gate 214 instead about the first axis A1.

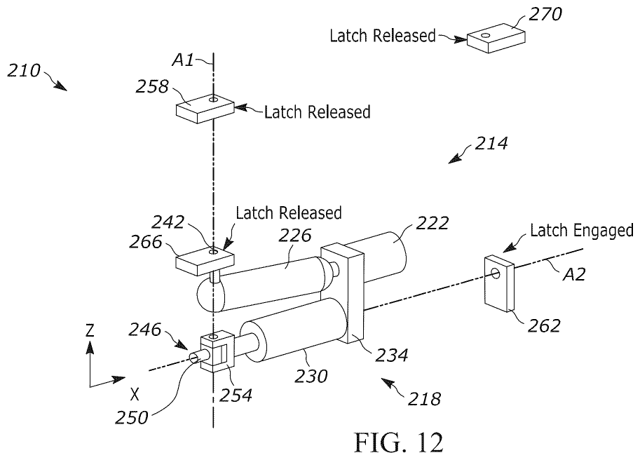

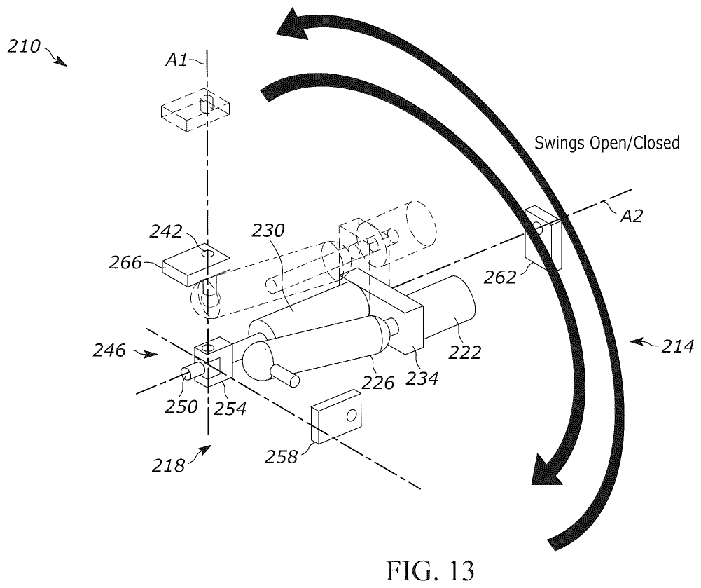

With reference to FIGS. 12 and 13, in some examples the power actuator system 218 may be free to rotate the gate 214 about the second axis A2 (in what may be considered a “lift” event) when both the first latch 258 and the third latch 266 are unlocked (e.g., released from the vehicle body 138 and/or the distal shaft 242) and the second latch 262 is locked (e.g., engaged with the vehicle body 138). In the illustrated example, and as described above, the dual action power gate 110 may additionally include the fourth latch 270. Accordingly, in the illustrated example the power actuator system 218 is free to rotate the gate 214 about the second axis A2 when each of the first latch 258, the third latch 266, and the fourth latch 270 are unlocked, and when the second latch 262 is locked.

To rotate the gate 214 about the second axis A2, the power actuator 122 may be activated (e.g., via the controller 238), thereby generating a force that is transmitted through the transmission 234 to the second power train 230. As described above, the transmission 234 may include a clutch or clutches or other structures that may be moved (e.g., via control from the controller 238) to shift the power output to the second power train 230 (as opposed to the first power train 226).

Because the first latch 258 is locked, the gate 214 is unable to rotate about the first axis A1. Accordingly, the power transmitted through the second power train 230 is directed (e.g., entirely) to rotating the gate 214 instead about the second axis A2.

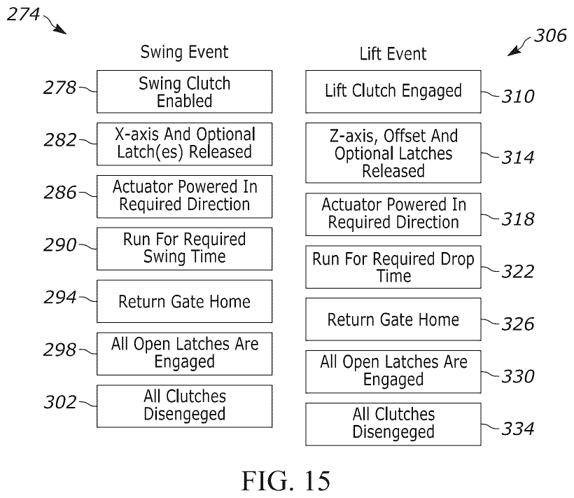

FIG. 15 illustrates an example of a control process 274 for a swing event of the dual action power gate 210. The control process 274 may be implemented, for example partially or entirely by the controller 238. As illustrated in FIG. 15, the control process 274 includes a step 278 of engaging a swing clutch (e.g., within the transmission 234). The control process 274 further includes a step 282 of releasing any appropriate latches (e.g., the second latch 262 and the fourth latch 270). The control process 274 further includes a step 286 of powering the power actuator 222 in a required direction (e.g., to cause a rotation of an output of the power actuator 222 in the transmission 234). The control process 274 further includes a step 290 of allowing the power actuator 222 to run for a specified period of time (i.e., a “swing” time). The control process 274 further includes a step 294 of returning the gate 214 back to a home position (e.g., by reversing the required direction). The control process 274 further includes a step 298 of engaging all open latches. The control process 274 further includes a step 302 of disengaging all clutches (e.g., in the transmission 234). Other examples of the control process 274 may include more, or fewer, steps than that illustrated.

FIG. 15 additionally illustrates an example of a control process 306 for a lift event of the dual action power gate 210. The control process 306 may be implemented, for example partially or entirely by the controller 238. As illustrated in FIG. 15, the control process 306 includes a step 310 of engaging a lift clutch (e.g., within the transmission 234). The control process 306 further includes a step 314 of releasing any appropriate latches (e.g., the first latch 258, the third latch 266, and the fourth latch 270). The control process 306 further includes a step 318 of powering the power actuator 222 in a required direction (e.g., to cause a rotation of an output of the power actuator 222 in the transmission 234). The control process 306 further includes a step 322 of allowing the power actuator 222 to run for a specified period of time (i.e., a “lift” time or “drop time”). The control process 306 further includes a step 326 of returning the gate 214 back to a home position (e.g., by reversing the required direction). The control process 306 further includes a step 330 of engaging all open latches. The control process 306 further includes a step 334 of disengaging all clutches (e.g., in the transmission 234). Other examples of the control process 306 may include more, or fewer, steps than that illustrated.

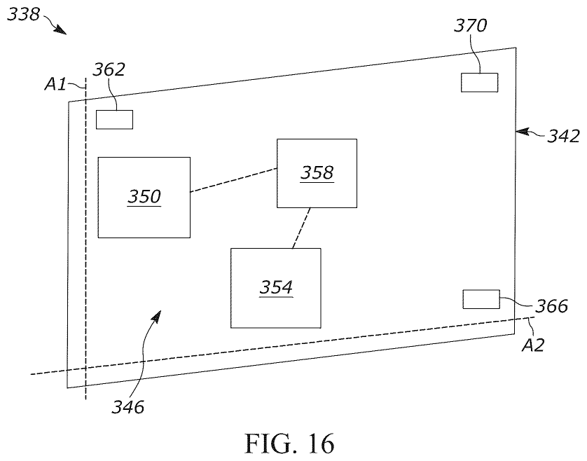

With reference to FIG. 16, another example of a dual action power gate 338 includes a gate 342 that rotates about each of the first axis A1 and the second axis A2. The gate 342 may be any type of gate, including for example lift gate on a vehicle, a tail gate on a vehicle, a hood on a vehicle, a frunk on a vehicle, or a side door on a vehicle.

The dual action power gate 338 further includes a power actuator system 346 coupled to the gate 342 to rotate the gate 342 about each of the first axis A1 and the second axis A2. The power actuator system 346 includes a first power actuator 350 to rotate the gate 342 about the first axis A1, and a second (and separate) power actuator 354 to rotate the gate 342 about the second axis A1. The first power actuator 350 may be any type of power actuator, including for example an electric motor or other type of motor or actuator. Similarly, the second power actuator 354 may be any type of power actuator, including for example an electric motor or other type of motor or actuator.

The power actuator system 346 may further include a controller 358 coupled to each of the first power actuator 350 and the second power actuator 354, to separately control each of the first power actuator 350 and the second power actuator 354. Accordingly, the controller 358 may cause the first power actuator 350 to be activated (and the second power actuator 354 to be deactivated) when it is desired to rotate the gate 342 about the first axis A1, and may cause the second power actuator 354 to be activated (and the first power actuator 350 to be deactivated) when it is desired to rotate the gate 342 about the second axis A2. In other examples, the controller 358 may control only the first power actuator 350, and a second, separate controller may control the second power actuator 354.

The dual action power gate 338 may further include one or more latches (e.g., similar to the latches described above) that may be locked and unlocked relative to the vehicle body 138 (e.g., manually and/or via electronic control, such as through the use of the controller 358). The latch or latches may be used, for example, to control (e.g., inhibit or permit) movement of the gate 342 about the first axis A1 and/or the second axis A2. For example, and as illustrated in FIG. 16, the dual action power gate 338 may include a fist latch 362 that is locked (e.g., to the vehicle body 138) when it is desired to rotate the gate 342 about the first axis A1, and a second latch 366 that is locked (e.g., to the vehicle body 138) when it is desired to rotate the gate 342 about the second axis A2. In some examples the dual action power gate 338 may further include a third latch 370.

While various examples of dual action power gates and their components are described above, it is understood that one or more of the components of any of the dual action power gates may be used in combination with one or more of the components of any of the other dual action power gates. Accordingly, one or more of the power actuator systems (or components thereof) may be used in combination with any of the latches described herein, and/or with other components.

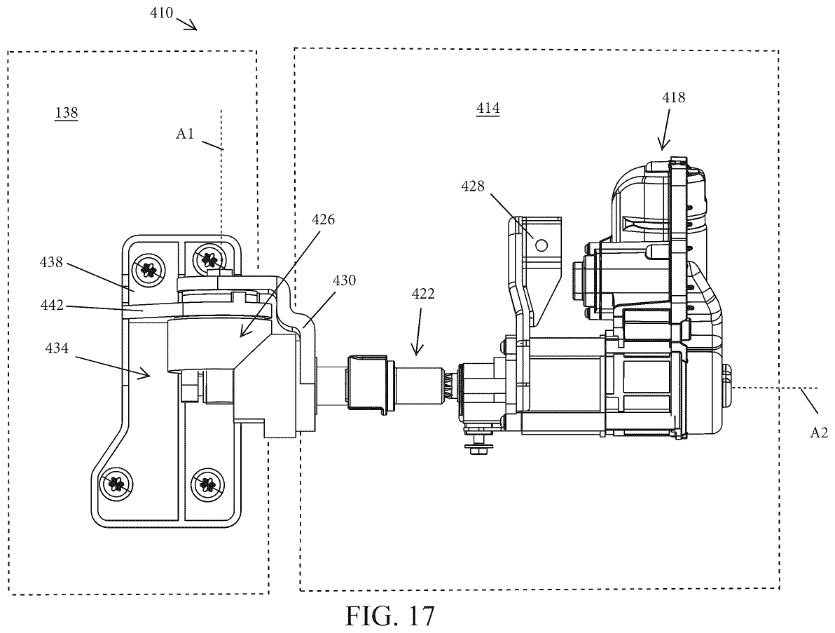

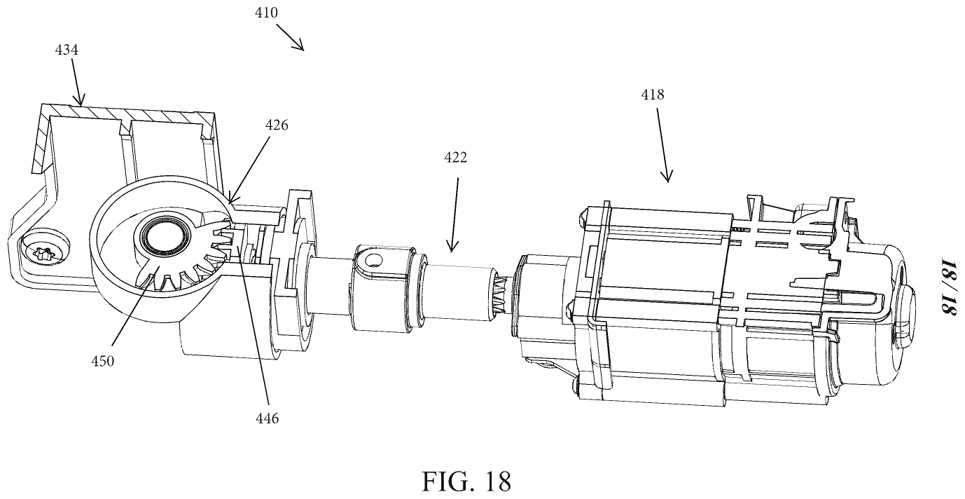

FIGS. 17 and 18 illustrate an example of a portion of a power gate 410. Similar to power gates 110, 210, and 338 described above, the power gate 410 may include a gate 414 (illustrated schematically in FIG. 17) that rotates about one or more axes (e.g., the first axis A1 and/or the second axis A2).

With continued reference to FIGS. 17 and 18, the dual action power gate 410 includes a power actuator 418, a power actuator output member 422 (e.g., an output shaft) coupled to and extending from the power actuator 418, and/or a gearbox 426 coupled to the power actuator output member 422. The power actuator 418 may be an electric motor coupled (e.g., at least partially fixed) to the gate 414 (e.g., with a reinforcing bracket 428), such that the power actuator 418 moves with the gate 414 when the gate 414 rotates (e.g., about the first axis A1 and/or the second axis A2).

In the illustrated example, and as seen in FIG. 17, the gearbox 426 is coupled to a first bracket 430 that rotates about the axis A1 when the gate 414 swings open about the first axis A1. The first bracket 430 is coupled to a second bracket 434 and movable relative to the second bracket 434. The second bracket 434 is coupled (e.g., fixed) to the vehicle body 138 (e.g., to a D-pillar). The second bracket 434 includes a first bracket portion 438 and a second bracket portion 442 that extends (e.g., perpendicularly) outwardly from the first bracket portion 438. Other examples include other numbers and/or arrangements of brackets.

In some examples, and as seen in FIG. 18, the gearbox 426 houses a first gear 446 (e.g., bevel gear or ring gear) and a second gear 450 (e.g., bevel gear or ring gear). Other examples include other numbers and/or arrangements of gears.

With continued reference to FIGS. 17 and 18, when the power actuator 418 is activated, the first gear 446 engages the second gear 450. If one or more latches are latched (e.g., similar to the latch 154 described above and seen in FIG. 2) and one or more latches are unlatched (e.g., similar to the latches 158 and 162 described above and seen in FIG. 2) to inhibit swinging motion about the second axis A2, the gate 414 swings about the first axis A1. Accordingly, and with reference to FIG. 17, the gearbox 426, the first bracket 430, the output member 422, the power actuator 418, and the gate 414 all swing together about the first axis A1.

Conversely, if one or more latches are latched (e.g., similar to the latch 158 described above and seen in FIG. 4) and one or more latches are unlatched (e.g., similar to the latches 154 and 162 described above and seen in FIG. 4) to inhibit swinging motion about the first axis A1, the gate 414 instead swings about the second axis A2. Accordingly, and with reference to FIG. 17, everything between the output member 422 and the vehicle body 138 remains in place (i.e., is stationary), while the power actuator 418 and the gate 414 rotate about the second axis A2.

Some of the examples may be further described by reference to the following numbered clauses:

1. A dual action power gate comprising:
a gate that is configured to rotate about a first axis and a second axis different than the first axis; and
a power actuator system coupled to the gate and configured to rotate the gate about each of the first axis and the second axis.

2. The dual action power gate of clause 1, wherein the first axis is perpendicular to the second axis.

3. The dual action power gate of any of the preceding clauses, wherein the power actuator system includes a power actuator and a gearbox coupled to the power actuator.

4. The dual action power gate of claim 3, further comprising a power actuator output member extending from the power actuator to the gearbox and coupling the power actuator to the gearbox.

5. The dual action power gate of claim 4, wherein the power actuator output member is a torsion shaft.

6. The dual action power gate of any of the preceding clauses, further comprising a first latch coupled to the gate and configured to be locked and unlocked from a vehicle body, and a second latch coupled to the gate and configured to be locked and unlocked from the vehicle body.

7. The dual action power gate of claim 6, wherein the power actuator system is free to rotate the gate about the first axis when the first latch is locked and the second latch is unlocked, and wherein the power actuator system is configured to rotate the gate about the second axis when the first latch is unlocked and the second latch is locked.

8. The dual action power gate of claim 7, further comprising a third latch coupled to the gate and configured to be locked and unlocked from the vehicle body.

9. The dual action power gate of claim 8, wherein the power actuator system is free to rotate the gate about the first axis when the first latch is locked and both the second latch and the third latch are unlocked, and wherein the power actuator system is configured to rotate the gate about the second axis when both the first latch and the third latch are unlocked and the second latch is locked.

10. The dual action power gate of any of the preceding clauses, wherein the gate is one of a lift gate on a vehicle, a tail gate on a vehicle, a hood on a vehicle, a frunk on a vehicle, or a side door on a vehicle.

11. The dual action power gate of any of the preceding clauses, wherein the power actuator system includes a power actuator, a linear power train coupled to the power actuator, and a rotational power train coupled to the power actuator.

12. The dual action power gate of clause 11, further comprising a clutch configured to shift power between the linear power train and the rotational power train.

13. The dual action power gate of clause 11 or clause 12, wherein the rotational power train is coupled to a dual hinge.

14. The dual action power gate of any of clauses 11-13, further comprising a first latch coupled to the gate and configured to be locked and unlocked from a vehicle body, and a second latch coupled to the gate and configured to be locked and unlocked from the vehicle body, wherein the power actuator system is free to rotate the gate about the first axis when the first latch is locked and the second latch is unlocked, and wherein the power actuator system is configured to rotate the gate about the second axis when the first latch is unlocked and the second latch is locked.

15. The dual action power gate of clause 14, further comprising a third latch, wherein the power actuator system is free to rotate the gate about the first axis when both the first latch and the third latch are locked and the second latch is unlocked, and wherein the power actuator system is configured to rotate the gate about the second axis when the second latch is locked and both the first latch and the third latch are unlocked.

16. The dual action power gate of clause 15, further comprising a fourth latch, wherein the power actuator system is configured to rotate the gate about the first axis when both the first latch and the third latch are locked and both the second latch and the fourth latch are unlocked, and wherein the power actuator system is free to rotate the gate about the second axis when each of the first latch, the third latch, and the fourth latch are unlocked and the second latch is locked.

17. The dual action power gate of any of clauses 11-16, wherein the gate is one of a lift gate on a vehicle, a tail gate on a vehicle, a hood on a vehicle, a frunk on a vehicle, or a side door on a vehicle.

18. The dual action power gate of any of the preceding clauses, wherein the power actuator system includes a first power actuator configured to rotate the gate about the first axis, and a second, separate power actuator configured to rotate the gate about the second axis.

19. The dual action power gate of clause 1, wherein the gate is one of a lift gate on a vehicle, a tail gate on a vehicle, a hood on a vehicle, a frunk on a vehicle, or a side door on a vehicle.

20. The dual action power gate of clause 1, further comprising a controller coupled to the power actuator system, wherein the controller is programmed to generate a swing event to rotate the gate about the first axis, and a lift event to rotate the gate about the second axis.

Although the disclosure has been described in detail referring to certain preferred embodiments, variations and modifications exist within the scope and spirit of one or more independent aspects of the disclosure as described.

What is claimed is:

1. A dual action power gate comprising:
a gate that is configured to rotate about a first axis and a second axis different than the first axis; and
a power actuator system coupled to the gate and configured to rotate the gate about each of the first axis and the second axis.

2. The dual action power gate of claim 1, wherein the first axis is perpendicular to the second axis.

3. The dual action power gate of claim 1, wherein the power actuator system includes a power actuator and a gearbox coupled to the power actuator.

4. The dual action power gate of claim 3, further comprising a power actuator output member extending from the power actuator to the gearbox and coupling the power actuator to the gearbox.

5. The dual action power gate of claim 4, wherein the power actuator output member is a torsion shaft.

6. The dual action power gate of claim 1, further comprising a first latch coupled to the gate and configured to be locked and unlocked from a vehicle body, and a second latch coupled to the gate and configured to be locked and unlocked from the vehicle body.

7. The dual action power gate of claim 6, wherein the power actuator system is free to rotate the gate about the first axis when the first latch is locked and the second latch is unlocked, and wherein the power actuator system is configured to rotate the gate about the second axis when the first latch is unlocked and the second latch is locked.

8. The dual action power gate of claim 7, further comprising a third latch coupled to the gate and configured to be locked and unlocked from the vehicle body.

9. The dual action power gate of claim 8, wherein the power actuator system is free to rotate the gate about the first axis when the first latch is locked and both the second latch and the third latch are unlocked, and wherein the power actuator system is configured to rotate the gate about the second axis when both the first latch and the third latch are unlocked and the second latch is locked.

10. The dual action power gate of claim 1, wherein the gate is one of a lift gate on a vehicle, a tail gate on a vehicle, a hood on a vehicle, a frunk on a vehicle, or a side door on a vehicle.

11. The dual action power gate of claim 1, wherein the power actuator system includes a power actuator, a linear power train coupled to the power actuator, and a rotational power train coupled to the power actuator.

12. The dual action power gate of claim 11, further comprising a clutch configured to shift power between the linear power train and the rotational power train.

13. The dual action power gate of claim 11, wherein the rotational power train is coupled to a dual hinge.

14. The dual action power gate of claim 11, further comprising a first latch coupled to the gate and configured to be locked and unlocked from a vehicle body, and a second latch coupled to the gate and configured to be locked and unlocked from the vehicle body, wherein the power actuator system is free to rotate the gate about the first axis when the first latch is locked and the second latch is unlocked, and wherein the power actuator system is configured to rotate the gate about the second axis when the first latch is unlocked and the second latch is locked.

15. The dual action power gate of claim 14, further comprising a third latch, wherein the power actuator system is free to rotate the gate about the first axis when both the first latch and the third latch are locked and the second latch is unlocked, and wherein the power actuator system is configured to rotate the gate about the second axis when the second latch is locked and both the first latch and the third latch are unlocked.

16. The dual action power gate of claim 15, further comprising a fourth latch, wherein the power actuator system is configured to rotate the gate about the first axis when both the first latch and the third latch are locked and both the second latch and the fourth latch are unlocked, and wherein the power actuator system is free to rotate the gate about the second axis when each of the first latch, the third latch, and the fourth latch are unlocked and the second latch is locked.

17. The dual action power gate of claim 11, wherein the gate is one of a lift gate on a vehicle, a tail gate on a vehicle, a hood on a vehicle, a frunk on a vehicle, or a side door on a vehicle.

18. The dual action power gate of claim 1, wherein the power actuator system includes a first power actuator configured to rotate the gate about the first axis, and a second, separate power actuator configured to rotate the gate about the second axis.

19. The dual action power gate of claim 1, wherein the gate is one of a lift gate on a vehicle, a tail gate on a vehicle, a hood on a vehicle, a frunk on a vehicle, or a side door on a vehicle.

20. The dual action power gate of claim 1, further comprising a controller coupled to the power actuator system, wherein the controller is programmed to generate a swing event to rotate the gate about the first axis, and a lift event to rotate the gate about the second axis.
